(19) United States
(12) Patent Application Publication
(10) Pub. No.: US 2004/0242150 A1
(43) Pub. Date: Dec. 2, 2004

(54) Systems, methods and transmission formats for providing a common platform for direct broadcast satellite television networks

(75) Inventors: Winston Hugh Wright, Rancho Palos Verdes, CA (US); Daniel Radke, Manhattan Beach, CA (US)

Correspondence Address: MYERS BIGEL SIBLEY & SAJOVEC, PO BOX 37428, RALEIGH, NC, 27627, US

(73) Assignee: Microspace Communications Corporation, Raleigh, NC

(21) Appl. No.: 10/446,543

(22) Filed: May 28, 2003

(51) Int. Cl. H04H 1/00; H04B 7/185

(52) U.S. Cl. 455/3.02; 455/12.1

(57) ABSTRACT

A common platform for Direct Broadcast Satellite (DBS) networks can transmit common programming among distinct DBS networks to the DBS receivers of both networks. By providing a common platform that can broadcast common television services to DBS receivers of two or more DBS networks, the DBS networks themselves can broadcast additional services, such as high definition TV and/or data services, using spectrum that is freed-up by the common platform. DBS receiving systems can include first and second DBS receivers. The first DBS receivers are configured to receive a first broadcast signal including first television services from a first satellite television network (for example, DirecTV). The second DBS receivers are configured to receive a second broadcast signal including second television services from a second satellite television network (for example, EchoStar). At least some of the first and second receivers are also configured to receive a common broadcast signal including common television services, from a common platform satellite television network.

### FIELD OF THE INVENTION

This invention relates to satellite communication systems, methods and transmission formats, and more particularly to direct broadcast satellite television systems, methods and transmission formats.

### BACKGROUND OF THE INVENTION

Direct Broadcast Satellite (DBS) television systems, methods and transmission formats are widely used to receive satellite television broadcasts. As is well known to those having skill in the art, a DBS system generally includes a ground segment, a space segment that includes one or more satellites and a plurality of DBS receivers which may include a small receiving antenna and a set-top box that connects to a television and/or other video monitor. The set-top box functionality may be integrated at least partially in a television and/or other device, such as a digital video recorder.

DBS systems are widely used throughout the world. For example in the United States, about one in eight households currently subscribes to a DBS service, a number expected to double within the next few years. DBS systems can offer a large number of television services. For example DBS systems can offer up to 300 or more television channels and other television services such as data services and interactive television.

In the United States, there are two DBS providers from which a consumer may choose: DirecTV® and the DISH Network provided by EchoStar Communications Corporation (“EchoStar”). These two DBS networks are incompatible, in that DirecTV DBS receivers cannot receive EchoStar broadcast signals and vice versa. Other DBS networks also may be provided in the U.S. in the future.

As DBS systems continue to expand, there is an increasing desire to expand the number of television services that are provided by the DBS systems. For example, there is an increasing desire to provide large numbers of additional channels for added programming, local TV coverage, high definition TV, data services and/or for other services. Unfortunately, however, DBS systems have a limited spectrum that is available to deliver services. Moreover, since the services are provided by satellites, there may be large regulatory, technological and/or economic barriers to increase this spectrum.

### SUMMARY OF THE INVENTION

Embodiments of the present invention provide a common platform for DBS networks that can transmit common services among distinct DBS networks to the DBS receivers of both networks. By providing a common platform that can broadcast common television services to DBS receivers of two or more DBS networks, the DBS networks themselves can broadcast additional services, such as high definition TV and/or data services, using spectrum that is freed-up by the common platform.

Embodiments of the invention may arise from a recognition that even though the two U.S. DBS networks are distinct and their DBS receivers are incompatible with one another, there is a considerable amount of overlap among the television services that are provided by both DBS networks. Thus, embodiments of the invention can broadcast at least some of these common services over a common platform for reception by DBS receivers of both networks. The DBS receivers of the existing networks can continue to receive programming from DirecTV if they are DirecTV receivers, or from EchoStar if they are EchoStar receivers. The need to duplicate broadcasts of programming at considerable capital, operating inefficiency and/or spectrum inefficiency can thereby be reduced or eliminated.

DBS television receiving systems according to some embodiments of the present invention include a plurality of first and second DBS receivers. The first DBS receivers are configured to receive a first broadcast signal including first television services from a first satellite television network (for example, DirecTV). The second DBS receivers are configured to receive a second broadcast signal including second television services from a second satellite television network (for example, EchoStar). At least some of the first and second receivers are also configured to receive a third broadcast signal including third television services, from a third satellite television network, for example a common platform satellite television network.

In some embodiments, the first DBS receivers are further configured to combine the first and third television services into a first user interface, for example the DirecTV user interface. The second DBS receivers are further configured to combine the second and third television services into a second user interface, for example the EchoStar user interface. More specifically, in some embodiments, the first user interface includes a first electronic program guide that includes the first and third television services, and the second user interface includes a second electronic program guide that includes the second and third television services.

In other embodiments of the present invention, authorization mechanisms are provided so that the third television services that are received by the first and second DBS receivers can only be accessed by authorized users. These authorization mechanisms may also allow authorized users to seamlessly receive television services from the common platform network as well as the first or second television network. More specifically, in some embodiments, the first broadcast signal includes therein first DBS receiver authorization messages and third DBS receiver authorization messages for the respective first and third services that are received at the first DBS receivers, and the second broadcast signal includes therein second DBS receiver authorization messages and third DBS receiver authorization messages for the respective second and third services that are received at the second DBS receivers. Moreover, in some embodiments, the third broadcast signal includes therein the first, second and third DBS receiver authorization messages for the respective first, second and third services that are received at the first and second DBS receivers. Thus, authorization messages may be received by the first and second DBS receivers, regardless of whether they are receiving the first or second broadcast signals or the common (third) broadcast signal.

In still other embodiments, the first broadcast signal also includes first authentication messages that are associated with the first television services, the second broadcast signal also includes second authentication messages that are associated with the second television services and the third broadcast signal also includes third authentication messages that are associated with the third television services. In some embodiments, the first DBS receivers are configured to store authorized service information from selected ones of the first and third authorization messages therein, and to use a first authentication message or a third authentication message that is associated with a respective first or third television service that is selected by a user of a first DBS receiver, to descramble the respective first or third television service that is selected by the user of the first DBS receiver, if the respective first or third television service that is selected by the user is authorized by the authorized service information from a respective first or third authorization message that is stored in the DBS receiver. The second DBS receivers are configured to store authorized service information from selected ones of the second and third authorization messages therein, and to use a second authentication message or a third authentication message that is associated with a respective second or third television service that is selected by a user of a second DBS receiver, to descramble the respective second or third television service that is selected by the user of the second DBS receiver, if the respective second or third television service that is selected by the user is authorized by the authorized service information from a respective second or third authorization message that is stored in the second DBS receiver. Thus, a television service may only be provided at a DBS receiver if the user is authorized to receive the service, regardless of whether the service is provided by the common platform or the individual DBS networks.

In some embodiments of the present invention, the first DBS receivers include a first and a third smart card coupled thereto. The first smart card stores therein the authorized service information from the selected ones of the first authorization messages and the third smart card stores therein the authorized service information from the selected ones of the third authorization messages. In other embodiments, the second DBS receiver also includes a second and a third smart card coupled thereto, wherein the second smart card stores therein the authorized service information from the selected ones of the second authorization messages and wherein the third smart card stores therein the authorized service information from the selected ones of the third authorization messages. In yet other embodiments, the second and/or first DBS receiver includes a fourth smart card coupled thereto, wherein the fourth smart card stores therein the authorized service information from the selected ones of the second authorization messages and the authorized service information from the selected ones of the third authorization messages therein.

In some embodiments of the present invention, the first and third DBS receiver authorization messages may be configured as Digital Video Broadcasting (DVB) compatible Entitlement Management Messages (EMM). In other embodiments, the second DBS receiver authorization messages also may be configured as DVB compatible EMMs. Moreover, in some embodiments, the third authentication messages are configured as DVB compatible Entitlement Control Messages (ECM). In other embodiments, the first and/or second DBS receiver authentication messages may also be configured as DVB compatible ECMs. Accordingly, the DVB standard may be used to implement at least part of the common platform in some embodiments of the present invention.

Other embodiments of the present invention include a first space segment that is configured to broadcast the first broadcast signal, a second space segment that is configured to broadcast the second broadcast signal and a third space segment that is configured to broadcast the third broadcast signal. In other embodiments, a first ground segment is configured to obtain the first television services for the first satellite television network, a second ground segment is configured to obtain the second television services for the second satellite television network and a third ground segment is configured to obtain the third television services for the first and second television networks. Moreover, the first ground segment may be configured to provide authorization messages for the first and third television networks. The second ground segment may be configured to provide authorization messages for the second and third satellite television networks. The third ground segment may be configured to provide authorization messages for the third television network, as well as the first and/or second television networks.

It will be understood that the above description has related primarily to DBS receiving systems. However, individual components thereof such as ground segments, space segments and individual DBS receivers also may be provided according to other embodiments of the present invention. Moreover, a DBS television transmission format that includes the authorization and/or authentication messages along with the television services as described above, may be provided. Finally, DBS television transmitting and receiving methods and methods to add capacity for first and second DBS networks and to add capacity to DBS receivers also may be provided. It also will be understood that embodiments of the invention may be used to add a common platform for common services among distinct subscription services within a single DBS network.

### BRIEF DESCRIPTION OF THE DRAWINGS

FIG. 1 is a block diagram of direct broadcast satellite systems and methods according to some embodiments of the present invention.

FIG. 2 is a block diagram of conventional independent direct broadcast satellite networks.

FIG. 3 is a block diagram of direct broadcast satellite television systems and methods according to other embodiments of the present invention.

FIGS. 4A and 4B are block diagrams of first and second direct broadcast satellite receivers and methods according to some embodiments of the present invention.

FIGS. 5A and 5B are block diagrams of first and second direct broadcast satellite receivers, methods and transmission formats according to other embodiments of the present invention.

FIG. 6 is a block diagram of a conventional SimulCrypt system.

FIG. 7 is a block diagram of systems, methods and transmission formats according to still other embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that although the terms first and second are used herein to describe various elements, these elements should not be limited by these terms. These terms are only used to distinguish one element from another element. Thus, for example, a first element discussed below may be termed a second element, and similarly, a second element may be termed a first element without departing from the teachings of the present invention.

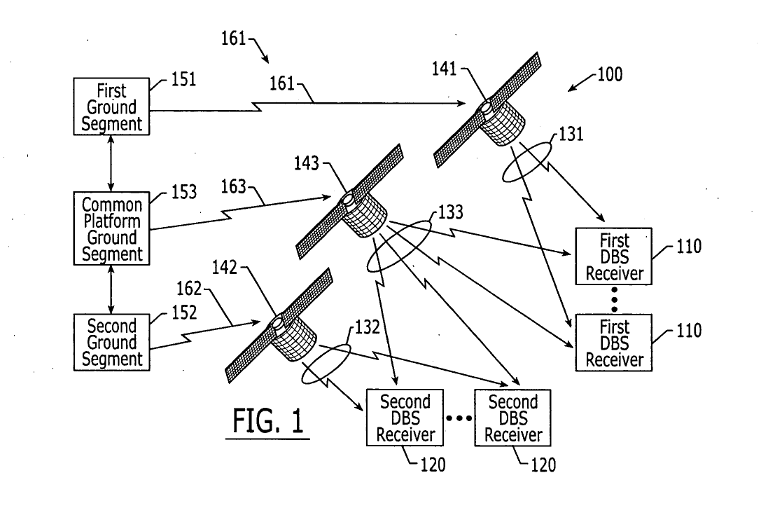

FIG. 1 is a block diagram of DBS systems and methods according to some embodiments of the present invention. As shown in FIG. 1, these DBS systems and methods 100 include a plurality of first DBS receivers 110 and a plurality of second DBS receivers 120. As is well known to those having skill in the art, a DBS receiver 110 or 120 can include an antenna, amplifier and down-converter, also referred to as an OutDoor Unit (ODU), and a Set-Top Box (STB). However, at least some of the set-top box functionality may also be included in a television, a recording device, a home controller and/or other devices, as is well known to those having skill in the art. In some embodiments, the first DBS receivers 110 are DirecTV receivers and the second DBS receivers 120 are EchoStar receivers, which have been modified as will be described below. It will be understood that the first and second DBS receivers 110 and 120 typically occupy overlapping geographical areas, but they need not do so. The design and operation of a conventional DirecTV or EchoStar receiver are well known to those having skill in the art and need not be described further herein.

As shown in FIG. 1, the first DBS receivers 110 are configured to receive a first broadcast signal 131 including first television services, from a first satellite television network that may include a first ground segment 151, a first uplink signal 161, and a first space segment, such as a first satellite 141. The second DBS receivers: 120 are configured to receive a second broadcast signal 132, including second television services, from a second satellite television network that may include a second ground segment 152, a second uplink signal 162, and second space segment such as a second satellite 142. It will be understood that as used herein, a television service can include one or more television channels such as HBO or ESPN, a television event such as a pay-per view event, a local channel, a data service and/or an interactive television service. The design of the first ground segment 151, the second ground segment 152, the first space segment 141, and the second space segment 142 are well known to those having skill in the art and need not be described further herein.

Still referring to FIG. 1, according to some embodiments of the present invention, at least some of the first and second DBS receivers 110 and 120 are also configured to receive a third broadcast signal, also referred to as a common or common platform broadcast signal 133, including third television services, also referred to as common or common platform television services, from a third television network, also referred to as a common or common platform television network that includes a common platform (or common or third) ground segment 153, a common platform (or common or third) uplink signal 163 and a common platform (or common or third) space segment such as a common platform (or common or third) satellites 143.

Accordingly, embodiments of the present invention allow at least some television services that are common offerings of the first and second television networks to be provided to the first and second DBS receivers 110 and 120 via a third (common or common platform) satellite television network. As also illustrated in FIG. 1, the ground segments 151, 152 and 153 may communicate with one another, for example to pass authorization and/or authentication messages, as will be described in detail below. The first and second television networks may continue to provide unique television services, and may also provide some common television services. However, the third satellite television network can allow at least some of the common television services to be broadcast therefrom, to thereby reduce or eliminate the need to duplicate capacity in the first and second television networks. It also will be understood that more than two existing DBS networks may be served by the common platform even though only two existing DBS networks are illustrated in FIG. 1. Accordingly, embodiments of the present invention can conserve DBS spectrum by allowing a single transmission of at least some overlapping television services rather than the current multiple transmissions.

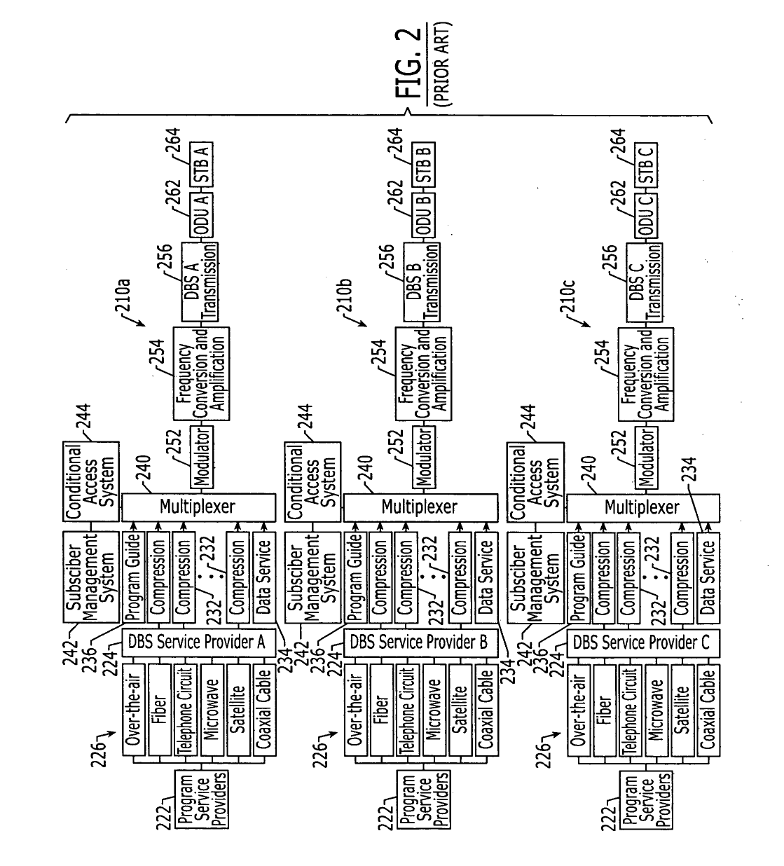

Embodiments of the invention as described in FIG. 1, may be contrasted with conventional independent DBS networks as they presently exist, for example in the United States. FIG. 2 is a block diagram of conventional independent DBS networks 210a, 210b, 210c. In each of the independent DBS networks, one or more program service providers 222 provide program content to a DBS service provider 224 using one or more connection media 226, such as over-the-air, fiber, telephone, microwave, satellite, coaxial cable and/or other conventional media. The DBS service provider 224, such as DirecTV or EchoStar, uses compression 232 and/or other techniques and combines the television services from the program service providers 222, along with data services 234 and/or a program guide 236, using a multiplexer 240. A subscriber management system 242 may be used to control the addition, deletion and/or modification of subscribers, and grant access to the various television services using a conditional access system 244. The multiplexed signal 240 is then modulated at a modulator 252, may undergo frequency conversion and amplification 254, and transmission 256 via a space segment including a satellite. The broadcast signal is received by an outdoor unit 262, and processed in a set-top box 264 or its equivalent.

Accordingly, as shown in FIG. 2, independent DBS systems 210a, 210b, 210c duplicate services in the ground segment (backhaul), uplink and space segment (satellite) transmission. These systems may generally employ different (incompatible) technologies, some of which may be proprietary. Thus, as shown in FIG. 2, the various programming service providers 222 transmit their signals to uplink stations of a DBS service provider 224. The several uplink stations collect the various sources of programming information, compress the signals and organize them into transport streams using formats that can be different from service provider to service provider. The uplink stations then multiplex the information together using multiplexers 240, scramble and encrypt the information, add program guide information and modulate the signals onto carriers using modulators 252. The techniques for transport stream formatting, scrambling, encrypting, furnishing program guide information and modulation, can differ from service provider to service provider. The uplink stations also convert the modulated carriers to frequencies corresponding to the transponders of the satellites and amplify the signals for transmission to multiple satellites. The operations are performed on many of the same programming sources by each of the DBS service providers.

Standardized or compatible technologies are known for transport, compression, scrambling, encryption, program guide and data services, such that a given STB can be used with multiple service providers from either the same or different satellite systems. Additionally, Digital Video Broadcasting (DVB) provides one such common standard. DVB allows the same standardized broadcast services to be separately authorized by different conditional access systems using the DVB standardized SimulCrypt technology. The design of DVB and Simulcrypt is well known to those having skill in the art and is described, for example, in the following publications by the European Telecommunications Standards Institute (ETSI): Digital Video Broadcasting (DVB); DVB SimulCrypt; Part 1: Head-end architecture and synchronization; TS101 197-V1.1.1 (1997-06); Digital Video Broadcasting (DVB); DVB SimulCrypt; Head-end architecture and synchronization, ETSI TS 101 197 V1.2.1 (2002-02); Digital Video Broadcasting (DVB); Implementation Guidelines of the DVB Simulcrypt Standard, ETSI TR 102 035 V1.1.1 (2002-04); and Digital Video Broadcasting (DVB); Head-end implementation of DVB SimulCrypt, ETSI TS 103 197 V1.3.1 (2003-01), the disclosures of which are hereby incorporated herein in their entirety as if set forth fully herein. Other publications may be found at the “ETSI Publications Download Area” of the ETSI website, at etsi.org.

Some embodiments of the present invention as described in FIG. 1, can conserve DBS spectrum by allowing a single transmission of at least some programming, rather than conventional multiple transmissions. Some embodiments of the present invention can also save space segment costs, including launch vehicle, satellite, spacecraft and/or operations costs, by avoiding at least some duplication of satellite transmissions. Some embodiments of the present invention can also save ground segment costs including signal backhaul to DBS uplink sites, uplink equipment, uplink operations and/or other costs. Some embodiments of the present invention can also provide a uniform platform for data delivery and/or interactive television services.

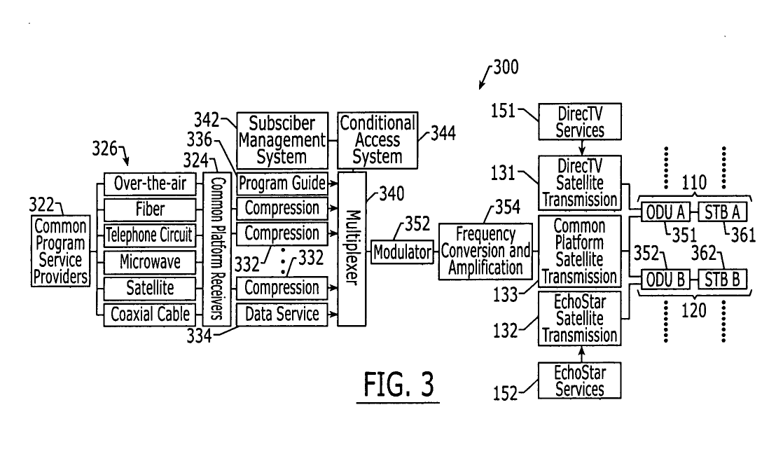

FIG. 3 is a block diagram of DBS systems and methods according to other embodiments of the present invention. These embodiments illustrate how conventional ground segments may continue to be used while adding a common platform (third) satellite television network.

In particular, referring to FIG. 3, a first ground segment 151 can provide, for example, DirecTV services, to provide a first broadcast signal 131. A second ground segment 152, such as an EchoStar ground segment, may be used to provide a second, such as an EchoStar, broadcast signal 132. In some embodiments, the common platform may use components that are similar to the satellite television network components that were described in FIG. 2. Thus, for example, the common program service providers 322, the common platform receivers 324, the connection media 326, the compression 332, the data service 334, the program guide 336, the multiplexer 340, the subscriber management system 342, the conditional access system 344, the modulator 352, and the frequency conversion and amplification 354 may provide functionality that is analogous to the 200 series blocks of FIG. 2. First DBS receivers 110, which, in some embodiments, include first ODUs 351 and first STBs 361, can receive the first broadcast signal 131 and the third (common platform) broadcast signal 133, for example, from first and third orbital slots. Second DBS receivers 120 which, in some embodiments, include second ODUs 352 and second STBs 362, can receive the second broadcast signals 132, as well as the third (common platform) broadcast signal 133, for example, from second and third orbital slots.

Accordingly, as shown in FIG. 3, a common platform DBS satellite television network provides a common platform for some services in addition to supporting distinct services from multiple services providers who use different technologies. Thus, the STBs 361, 362 of FIG. 3 can support two modes of operation: distinct DBS services such as DirecTV or EchoStar services and common platform services. As will be described below, these services may be provided through a common user interface. Each of the DBS and common platform services employs its own satellite system, so that the programming from more than one satellite system is received by an individual subscriber. As shown in FIG. 3, as was the case for the independent DBS systems of FIG. 2, various programming sources transmit programming to an uplink station. However, in some embodiments of the present invention, a given program may be transmitted to only one uplink station. It will be understood that the common platform can have more than one uplink station in order to provide local or regional services. In some embodiments, a source of programming can send its content to only one of these common uplink stations. This operation can be performed once on behalf of all service providers.

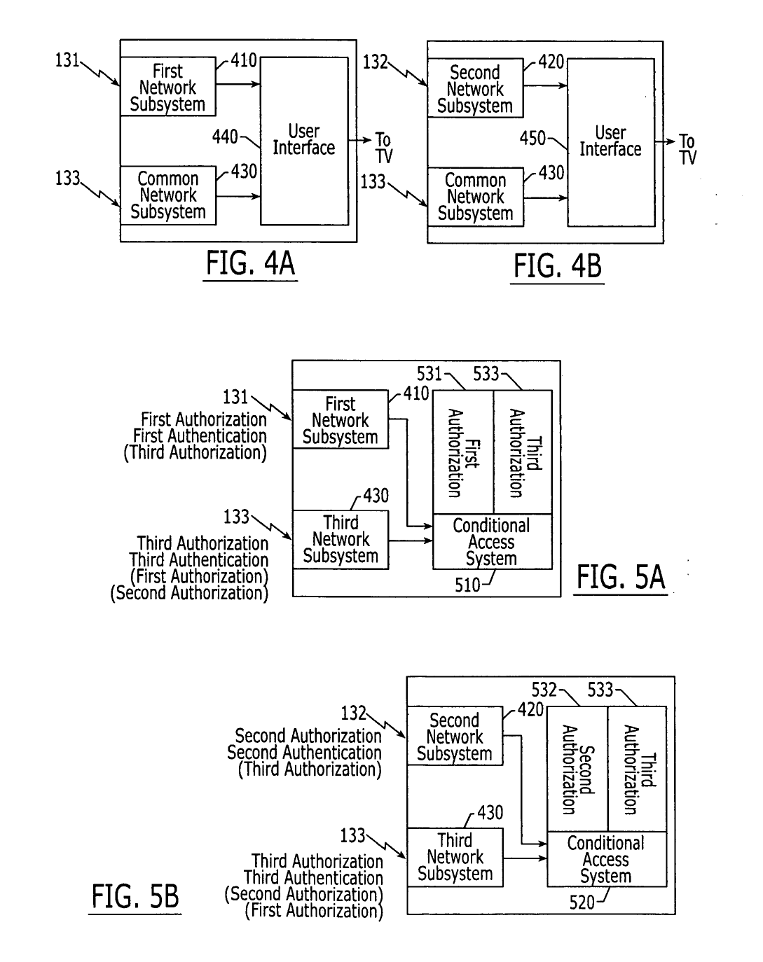

FIGS. 4A and 4B are block diagrams of respective first and second DBS receivers, such as respective first and second DBS receivers 110 and 120 of FIGS. 1 and 3, according to some embodiments of the invention. As shown in FIG. 4A, the first DBS receivers include a first network subsystem 410 that is configured to receive a first broadcast signal 131, including first television services from the first satellite television network. A common network subsystem 430 is configured to receive the common (third) broadcast signal 133, including common television services from the common satellite television network. It will be understood that the functionality of the first network subsystem 410 and the common network subsystem 430 may be provided using common and/or distinct components. A user interface generator 440 is configured to combine the first and second television services into a first user interface. In some embodiments, the first user interface corresponds to the standard user interface that is used by the first television network. Thus, for example, the standard DirecTV user interface may be used to integrate the first television services that are received from the DirecTV network and the third television services that are received from the common platform satellite television network into the standard DirecTV user interface. More services may be included than in standard DirecTV, but the user interface can remain the standard DirecTV user interface. Thus, for example, the standard DirecTV electronic program guide may be used, that lists both the first and third television services.

FIG. 4B illustrates second DBS receivers that include a second network subsystem 420 that is configured to receive the second broadcast signal 132 and a common (third) network subsystem 430 that is configured to receive the common broadcast signal 133. It will be understood that the functionality of the second network subsystem 420 and the common network subsystem 430 may be provided using common and/or distinct components. A user interface generator 450 may be used to combine the second and third television services. In some embodiments, the standard EchoStar user interface may be used, but can display both the EchoStar programming and the common programming. In other embodiments, a EchoStar electronic program guide may be used to display all of the second and third television services that are received. Outputs of the DBS receivers of FIGS. 4A and 4B may be provided to a television, monitor, other display and/or processing device.

FIGS. 5A and 5B are block diagrams of other embodiments of first and second DBS receivers, such as respective first and second DBS receivers 110 and 120 of FIGS. 1 and 3, and DBS television transmission signal formats according to other embodiments of the present invention. It will be understood that embodiments of FIGS. 4A and 4B may be combined with embodiments of FIGS. 5A and 5B.

Referring now to FIG. 5A, the first broadcast signal 131 also includes therein first DBS receiver authorization messages for the first services that are received at the first DBS receiver. Optionally, the first broadcast signal 131 may also include third DBS receiver authorization messages (indicated in parenthesis in FIG. 5A) for the third services that are received at the first DBS receiver. The third broadcast signal 133 may include therein the third authorization messages for the third services that are received at the first DBS receiver. A conditional access system 510 is configured to store authorized service information from selected ones of the first authorization messages in a first storage device 531, and authorized service information from selected ones of the third authorization messages in a third storage device 533. The first and third authorization messages are selected based upon an address or other identifier in the first or third authorization messages corresponding to the address or other identifier of the particular first DBS receiver and/or conditional access device, such as a smart card. In some embodiments, the first and third storage media 531 and 533 comprise first and third smart cards. In other embodiments, the first and third storage media 531 and 533 comprise a single smart card. In still other embodiments, the first and third storage media correspond to other conventional storage media such as one or more flash memory devices.

The conditional access system 510 is configured to allow conditional access to a first or third television service that is selected by a user of the first DBS receiver, by using the authorized service information from a first authentication message or a third authentication message that is associated with a respective first or third television service selected by a user of the first DBS receiver, to descramble the selected first or third television service, if the selected first or third television service that is selected by the user is authorized by the authorized service information from a respective first or third authorization message that is stored in the first DBS receiver. Thus, the stored authorized service information from the received authorization messages is compared to the authentication message that accompanies a service that is selected by a user. If a match occurs, then a control word is generated that is used to descramble the first and/or third broadcast signal.

It will be understood that the third authorization messages may be included in the first broadcast signal 131 (as shown in parenthesis in FIG. 5A) and the first authorization messages may be included in the third broadcast signal 133 (as shown in parenthesis in FIG. 5A), so as to allow an authorization message to be received by the DBS receiver in a timely manner, regardless of whether the DBS receiver is tuned to the first broadcast signal 131 or the third broadcast signal 133. In other embodiments, these additional authorization messages need not be included, at the potential expense of introducing additional delay when attempting to view a service for which an authorization message has not already been stored.

Referring now to FIG. 5B, the second broadcast signal 132 also includes therein second DBS receiver authorization messages for the second services that are received at the second DBS receiver. Optionally, the second broadcast signal 132 may also include the third DBS receiver authorization messages (indicated in parenthesis in FIG. 5B) for the third services that are received at the second DBS receivers. The third broadcast signal 133 may include therein the third authorization messages for the third services that are received at the second DBS receiver. A conditional access system 520 is configured to store authorized service information from selected ones of the second authorization messages in a second storage device 532, and authorized service information from selected ones of the third authorization messages in a third storage device 533. The second and third authorization messages are selected based upon an address or other identifier in the second or third authorization messages corresponding to the address or other identifier of the particular second DBS receiver and/or conditional access device such as a smart card. In some embodiments, the second and third storage media 532 and 533 comprise second and third smart cards. In other embodiments, the second and third storage media 532 and 533 comprise a single smart card. In still other embodiments, the second and third storage media correspond to other conventional storage media such as one or more flash memory devices.

The conditional access system 520 is configured to allow conditional access to a second or third television service that is selected by a user of the second DBS receiver, by using the authorized service information from a second authentication message or a third authentication message that is associated with a respective second or third television service selected by a user of the second DBS receiver, to descramble the selected second or third television service, if the selected second or third television service that is selected by the user is authorized by the authorized service information from a respective second or third authorization message that is stored in the second DBS receiver. Thus, the stored authorized service information from the received authorization messages is compared to the authentication message that accompanies a service that is selected by a user. If a match occurs, then a control word is generated that is used to descramble the first or third broadcast signal.

It will be understood that the third authorization messages may be included in the second broadcast signal 132 (as shown in parenthesis in FIG. 5B) and the second authorization messages may be included in the third broadcast signal 133 (as shown in parenthesis in FIG. 5B), so as to allow an authorization message to be received by the DBS receiver in a timely manner, regardless of whether the DBS receiver is tuned to the second broadcast signal 132 or the third broadcast signal 133. In other embodiments, these additional authorization messages need not be included, at the potential expense of introducing additional delay when attempting to view a service for which an authorization message has not already been stored.

When viewing FIGS. 5A and 5B collectively, it may be seen that, according to some embodiments of the present invention, the third (common) broadcast signal 133 can include the first authorization messages and the second authorization messages, in addition to the third authorization messages, so as to allow the first and/or second authorization messages to be received in a timely manner, even though the user is accessing the common broadcast signal 133. Thus, FIGS. 5A and 5B also illustrate DBS television transmission signal formats according to some embodiments of the present invention.

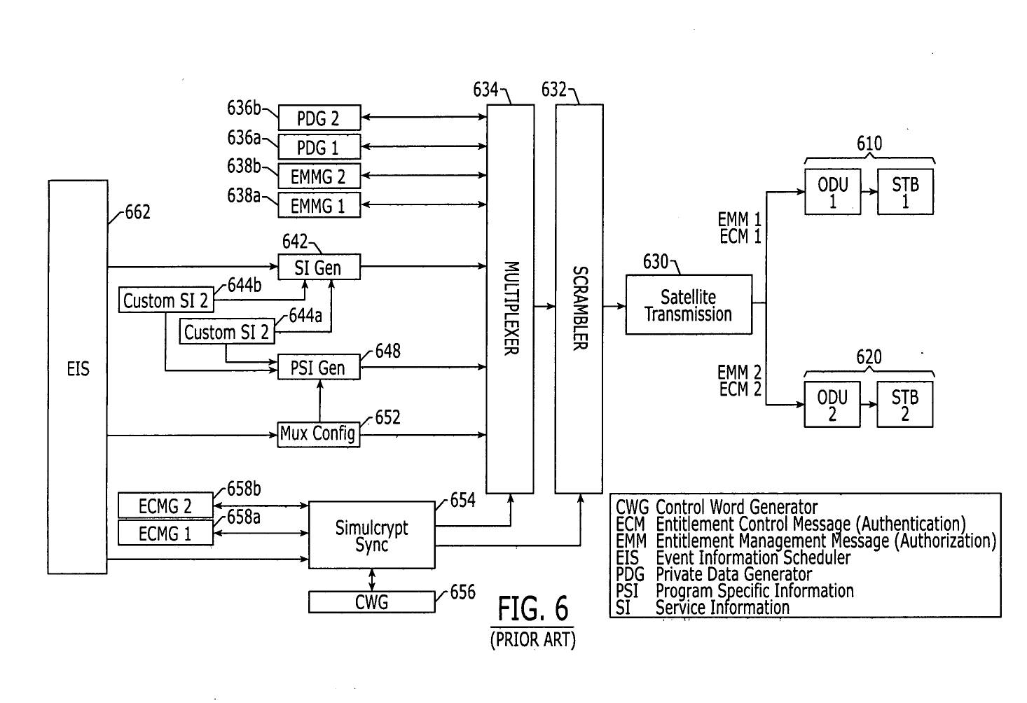

Embodiments of the present invention may use authorization and authentication messages, and message flows that are provided by the DVB standard that was described above; however, they need not do so. Moreover, embodiments of the invention may use SimulCrypt technology to provide coordinated control word generation and usage while using separate authorization and authentication processes, although SimulCrypt need not be used. In order to provide a basis for describing DVB authorization and authentication flow and SimulCrypt technologies that may be used in embodiments of the present invention, a description of conventional DVB authorization and authentication flow and conventional control word generation using SimulCrypt will first be described in connection with FIG. 6. Additional details may be found in the above-cited ETSI publications.

As shown in FIG. 6, SimulCrypt allows multiple (for example two) satellite television network providers to employ separate authorization processes using separate Entitlement Management Messages (EMM), and separate authentication processes using separate Entitlement Control Messages (ECM) in conjunction with a common scrambling algorithm using a common Control Word (CW). This is illustrated in FIG. 6 for two service providers.

FIG. 6 illustrates how the EMM and ECM flows for multiple conditional access systems are used in conjunction with a single CW generation process to authorize the same services. Thus, a single satellite transmission 630 can include therein first EMMs (EMM 1) for first DBS receivers 610, second EMMs (EMM 2) for second DBS receivers 620, first ECMs (ECM 1) for authenticating that a television service may be received in a first DBS receiver 610 and second authentication messages (ECM 2) for authenticating that a second television service may be received in a second DBS receiver 620.

More specifically, as shown in FIG. 6, service authorization using EMMs may be provided as follows:

1. A subscriber's request for service is entered into a Subscriber Management System (SMS).

2. The SMS generates an authorization request according to a service identification (ID), to a Subscriber Authorization Service (SAS). The service ID identifies particular service(s) such as channels, programs, data services, etc.

3. The SAS records and passes the request information to an EMM generator 638a, 638b, which generates an EMM.

4. The EMM is addressed to specific DBS receivers/smart cards 610, 620.

5. The EMM flows from the EMM generators 638a, 638b through a multiplexer 634 and a satellite 630 to a DBS receiver 610 or 620.

6. The DBS receiver demultiplexes the bitstream and determines whether the EMM is addressed to it.

7. If the EMM is addressed to it, the DBS receiver stores the authorized service ID, for example in a smart card that is associated therewith.

As also shown in FIG. 6, authentication may be performed in a SimulCrypt environment as follows:

1. A program (or service) is generated and scheduled by an Event Information Scheduler (EIS) 662 and/or a private data generator 636a, 636b.

2. A CW is generated by a Control Word Generator (CWG) 656 for the programming.

3. The CW that is generated by the CWG 656 is used by multiple ECM generators 658a, 658b, to form ECM1, ECM2, which are utilized by the respective STBs (STB 1, STB2) for the same service.

4. ECMs are inserted into the bitstream along with the use of the CW, to scramble the program. A SimulCrypt synchronizer 654, a multiplexer configurator 652, custom service information generators 644a, 644b, a service information generator 642, and the multiplexer 634 and a scrambler 632, may be used to insert the ECMs into the bitstream in synchronism with the use of the CW, to scramble the program.

5. A user of a DBS receiver 610, 620 selects a service.

6. Service information identifies the ECM stream corresponding with the selected service.

7. The DBS receiver passes the ECM to the smart card or other storage device.

8. The smart card compares the ECM service ID with the ID that was stored from the EMM.

9. If there is a match, the smart card or other storage device generates the CW.

10. The CW is delivered to the DBS receiver 610, 620 to descramble the selected service.

The processing flow for service authorization using EMMs and authentication using ECMs that was described above, can be used by a single service provider acting within a single DBS system, or by multiple service providers of common services using different conditional access systems in conjunction with a common scrambling algorithm. Thus, as shown in FIG. 6, the same authorization process can take place for multiple service providers selling the same program service over the same satellite system to different subscriber communities. The design and use of the DVB standard including SimulCrypt processing is well known to those having skill in the art, and need not be described further herein.

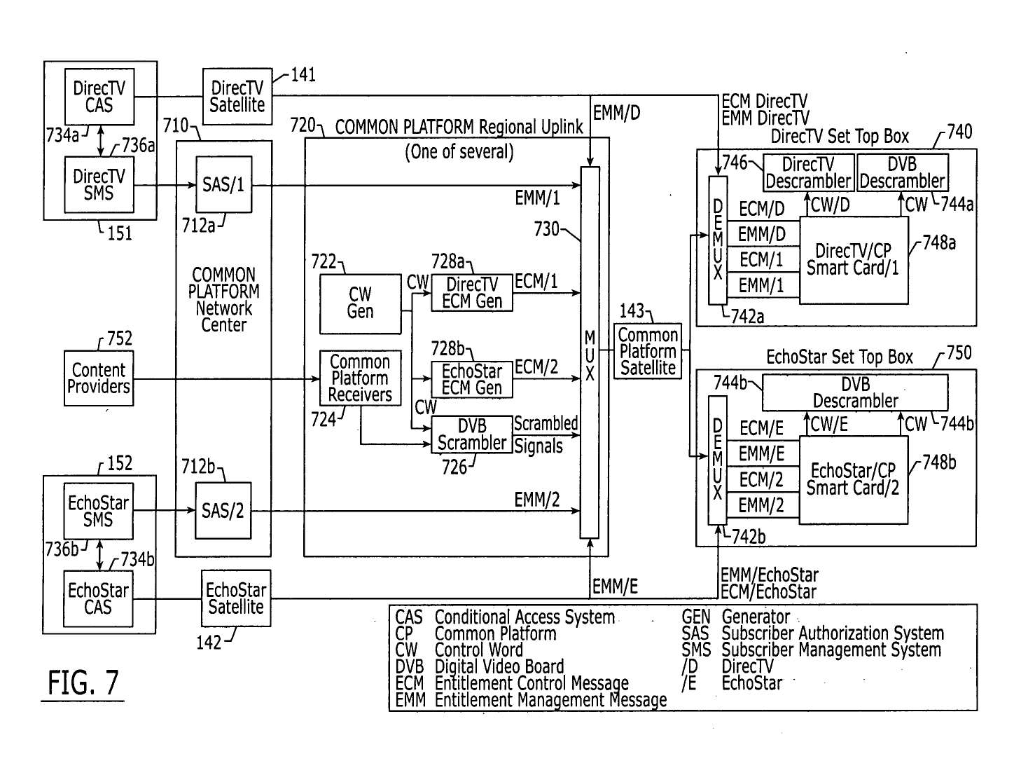

FIG. 7 is a block diagram that illustrates the use of the DVB standard and SimulCrypt in common platforms according to some embodiments of the invention, in connection with first and second DBS networks. For convenience, the first DBS network will be referred to as DirecTV and the second DBS network will be referred to as EchoStar. As shown in FIG. 7, these embodiments of the common platform allow EchoStar and DirecTV to separately authorize subscribers for the same common platform services, while also receiving their distinct services from their own satellite systems. It will be understood that other embodiments of the present invention need not use DVB or SimulCrypt technologies.

Referring to FIG. 7, a Conditional Access System (CAS) 734a, 734b is used to control access to programming provided on the common platform system. A conventional Event Information Scheduler (EIS) and/or similar function may be used to define the services carried on the common platform system. A Subscriber Authorization System (SAS) 712a, 712b nominally receives instructions for subscription packages from the DBS providers' Subscriber Management Systems (SMS) 736a, 736b. Thus, authorizations may be given from the DBS provider to the common platform SAS 712a, 712b for each subscriber. These authorizations can enable all channels within a defined market to be viewed by the subscriber. As shown in FIG. 7, there can be one common platform SAS or SAS interface 712a, 712b for each DBS service, allowing separate management. The SASs 712a, 712b can be collocated in a central common platform Network Center 710, which can be part of a common platform ground segment.

The common platform EIS provides for registration of incoming services from service providers and definition of services and allows the common platform to control signals that are carried on the common platform space segment such as satellite 143. As such, the EIS can be used to define channels or data streams that are to be filtered from the incoming feed of the content providers 752. Channels and data streams not registered in the common platform EIS can be removed from the common platform broadcast. Additionally, for channels that are to be passed, the common platform can use the EIS to define whether a given data stream is to have common platform conditional access applied, whether to pass-through the broadcasters conditional access, or whether to pass the signals unencrypted. Unencrypted mode can be applied to a data broadcast, for example, making the data available to all markets within a satellite downlink beam.

Services are aggregated by the common platform and uplinked from regional uplinks 720 throughout the country, which can be part, of a common platform ground segment. The common platform broadcast signal is received by multi-feed antennas and STBs 740, 750 and/or other DBS receiver components that can be tailored to be compatible with EchoStar and common platform services, or DirecTV and common platform services, respectively.

EMMs are used to write a subscription authorization onto a subscriber's smart card and/or other storage media in an STB. The EMM is sent from the conditional access system 734a, 734b when someone first subscribes, and periodically thereafter to renew the subscription. An EMM also may be used to cancel a subscription.

In some embodiments, a DirecTV subscriber may use an EMM from the DirecTV CAS 734a (EMM/D) as well as an EMM from common platform (EMM/1). Similarly, an EchoStar subscriber may use EMMs from the EchoStar CAS 734b (EMM/E) and from common platform (EMM/2). Because the DirecTV EMM could be transmitted to an STB 740 while the subscriber is tuned to a common platform channel, in some embodiments the common platform can carry its own and DirecTV (and EchoStar) EMMs in its transponders for seamless reception of EMMs without re-tuning. Similarly, common platform EMMs may be provided to the DBS uplinks for broadcast by them.

Common platform EMM streams (EMM/1 and EMM/2) are generated by the Subscriber Authorization Systems 712a, 712b in the common platform Network Center 710. The SASs 712a, 712b can be part of the conditional access system. A subscriber may always contact either DirecTV or EchoStar, and if the subscriber's request involves the common platform channels, it can lead to an electronic message from the DirecTV or EchoStar Subscriber Management System (SMS) 736a, 736b to the appropriate authorization system 712a, 712b at the common platform. The SASs 712 can generate common platform EMMs in response to these SMS messages.

A continual stream of Entitlement Control Messages (ECMs) can accompany every service or every program in a service. When a channel is selected, the ECM accompanying the program playing on that channel is sent to the smart card 748a, 748b in the STB 740, 750. The smart card 748a, 748b will check the ECM for authenticity, and if it is a valid control message, the smart card will compare the service ID in the message against the ID written on the card earlier by an EMM. If the IDs match, the subscriber is entitled to see the program and the card will compute a control word (key) and transfer it to a descrambler 744a, 744b, 746. The program content then is descrambled and displayed for the viewer.

ECMs may have different formats depending on the network. DirecTV and EchoStar can generate ECMs for their programs (ECM/D and ECM/E) and broadcast them to their subscribers. The common platform can generate ECMs for its programs so that subscribers can view common platform services. Using Simulcrypt and/or other technology, the common platform can generate two ECM streams for each service, one stream for DirecTV (ECM/1) and a second stream (ECM/2) for EchoStar subscribers. A DirecTV subscriber receives ECM/1 and an EchoStar subscriber receives ECM/2 for the given service.

The CWs are the keys that control the scrambling and unscrambling of the services. The CWs can change every few seconds and can be contained (e.g., hashed) in the ECMs. DirecTV and EchoStar send their own CWs to their subscribers via their ECMs. The common platform programs are viewed by both DirecTV and EchoStar subscribers and yet they can be scrambled only one way, i.e., the same CW is used whether a program is going to be viewed by a DirecTV or EchoStar subscriber.

The common platform uses a single control word generator 722 that sends control words to an ECM generator 728a for DirecTV subscribers and also to an ECM generator 728b for EchoStar subscribers. The CWs are also fed to a scrambler 726 that scrambles the common platform's local TV programs and services. The two ECM generators 728a, 728b produce ECMs (ECM/1 and ECM/2) that control access to common platform services for DirecTV and EchoStar subscribers, respectively. The ECMs, EMMs, and scrambled signals are multiplexed by a multiplexer 730 and broadcast over a common platform satellite 143.

The DVB standard has defined SimulCrypt that makes it possible for a service to have multiple ECMs and a common CW, thus allowing subscribers with STBs containing different CA systems to view the same programming. By using CA systems in the common platform that are compliant with DVB specifications, in some embodiments of the present invention, it becomes possible for a single CW to be used with ECM generators 728a, 728b creating messages for DirecTV and EchoStar subscribers. In the STBs 740, 750, after demultiplexing by demultiplexers 742a, 742b, the CW can be extracted by the DVB-compliant smart cards 748a, 748b of both DirecTV and EchoStar subscribers, and the DVB descrambler 744a, 744b in the STBs 740, 750, respectively, will use the common algorithm to provide the viewers with a clear signal.

In some embodiments, the common platform may use two or more DVB-compliant conditional access systems. Then, in these embodiments, the smart card(s) used for common platform services in the STB of a DirecTV subscriber may be provided by one company and the smart card(s) in the STB of an EchoStar subscriber may be provided by the other. The DirecTV STB may use a DirecTV descrambler 746 fed by the DirecTV control word (CW/D) when receiving DirecTV programming and a common platform DVB descrambler 744a fed by the common platform control word (CW) when receiving a common platform channel.

The situation can be simpler for EchoStar subscribers as EchoStar, like some embodiments of the common platform, uses a DVB-compliant conditional access system. The control words carried in EchoStar ECMs (CW/E) and those carried in common platform ECMs (CW) can be fed to the same DVB-compliant descrambler 744b. DVB-compliant smart cards 748b support the reception of CA messages from multiple operators/service providers.

Some embodiments of the invention can use extensions of standard functions for EMM handling and STBs that support the conditional access systems of DirecTV, EchoStar and potentially other service providers. In view of the above detailed description, the common platform business model can be implemented successfully with a single CAS provider with the uplink components coordinated with the respective providers of the STB smart cards.

To allow for seamless subscriber access to authorizations, some embodiments of the present invention allow for EMMs from DBS providers to be carried on the common platform satellites 143 and the common platform EMMs to be carried on DBS provider satellites 141, 142. Common platform EMMs may be furnished to the DBS providers for uplink injection. The handling of two EMM streams can be accommodated by extending conventional EMM capabilities, using an EMM combiner and/or separate EMM injection.

An EMM combiner is a conventional EMM injector that also can accept EMMs from an external connection and combine the two EMM streams into a single stream for single PID (Packet Identifier) injection into the multiplexer system. An EMM combiner can provide proper EMM formatting in accordance with DBS requirements and can maintain appropriate EMM spacing for a given smart card, to reduce or prevent simultaneous reception. Such a unit may replace existing EMM injectors at DBSs and can receive common platform EMMs from a downlink receiver. Likewise, such a unit may be used at a common platform Regional Uplink Center 720 to handle DBS EMMs. In contrast, a separate EMM injection scheme can allow DBSs to keep their existing EMM injectors, but the common platform EMMs may be injected into the DBS multiplexers as a data stream. STB processing can provide proper handling of the separate streams.

As shown in FIG. 7, in some embodiments, STBs 740, 750 can receive seamlessly from multiple orbital slots—one or more slots for existing DBS providers and another for the common platform. Moreover, the common platform can maintain a Network Center 710 that has the central SAS elements 712a, 712b and has an interface with the EchoStar and DirecTV SMSs 736a, 736b, to receive authorizations. Common platform EMMs can be sent via satellite from the network center 710 to regional uplinks 720 over national satellite beams on the common platform spacecraft 143 and/or can be sent terrestrially. The regional uplink centers 720 can re-broadcast the EMMs into local or national markets along with the local TV channels and/or services for reception by multi-feed consumer receivers. Each of the regional uplink centers can include remote ECM generators 728a, 728b. The common platform channels are scrambled in scrambler 726 at the regional uplink 720.

In some embodiments, the common platform can re-broadcast the DBS EMM streams (as received locally from the DBS satellites 141, 142) so that the consumer STBs 740, 750 can always receive DBS EMMs regardless of the services that are selected by the user. The added delay (for example, less than 2 seconds) for re-broadcasting EMMs should not cause any detriment in key update procedures as such delay is small enough relative to the transition period envisaged by either operator for key changes. In some embodiments, EchoStar and DirecTV can also re-broadcast the common platform EMM stream, as received locally from the common platform downlink, so that the STBs 740, 750 can receive common platform EMMs regardless which services are selected by the user. STBs 740, 750 may use smart card(s) 748a, 748b to descramble both DirecTV and common platform, or EchoStar and common platform, services. In some embodiments, common platform can use the transport streams that are defined by the DVB standards. DVB packets are used by EchoStar, while the DirecTV system uses a proprietary (DSS) packet format.

Other conventional DBS components may be used in some embodiments of the present invention, and may be modified in some embodiments, as will now be described. For example, commercially available chipsets can support both DVB and DSS transport formats and can allow dynamic switching between modes. Moreover, each current DBS system presently provides Electronic Program Guide (EPG) information by uplinking a data stream to its satellites. Embodiments of the invention can carry channel and program information that can be linked to identifiers in these DBS EPG data streams and/or can carry EPG data directly in the DVB format. The STB 740, 750 can manage the interaction with the consumer to present a seamless program guide. Embodiments of the invention also may replicate all or portions of the DBS EPGs to enhance performance.

Embodiments of the invention can use standards-based, such as DVB-based, modulation schemes that are supported in the chipsets used in the DBS/common platform STBs 740, 750, but the use of non-standard modulation technology is not precluded. The STBs can switch dynamically between DBS and common platform satellite transponders and their respective modulation schemes. Due to improvements in this field, the common platform modulation parameters may differ from those of current DBS. Common platform STBs 740, 750 can contain chipsets that can decode the DBS video and audio streams. There need be no restriction on the common platform video and audio formats—they can be identical to one of the DBS formats and/or different from them. In practice, they may be different, for example to take advantage of improvements in coding technology that can allow significantly better video and audio quality at the same bit rates, and/or to maintain the same quality while reducing bit rates.

Finally, a common platform antenna according to some embodiments of the invention can provide one or more feed horns pointed to the common platform satellite(s) 143. If the orbital location of the common platform satellite(s) 143 is near those of the direct broadcast satellites 141, 142, the common platform feed horn can be situated adjacent to DBS feed horns on the same antenna. The STBs 740, 750 can provide dynamic standards-based selection between the multiple feeds. Future DBS systems may be at orbital positions some distance from DirecTV and EchoStar satellites 141, 142. Depending on this distance, the DBS/common platform antenna may include a single reflector with multiple feed horns and/or individual reflectors for the DBS and common platform satellites.

In conclusion, DBS systems, methods and transmission formats according to some embodiments of the invention can deliver television services in an efficient manner to subscribers of DirecTV, EchoStar and future U.S. DBS networks. Embodiments of the invention can achieve efficiency by delivering the satellite signals in such a way that subscribers to distinct DBS networks are able to receive the same signals. Embodiments of the invention can allow subscribers of the DirecTV and EchoStar networks to receive the same signal, but reception is not limited to these networks. Future DBS network subscribers also may be able to receive the signal. A combination of space segment and ground segment equipment can provide a common platform for DBS networks. The common platform satellite system can be located in the vicinity of the satellites operated by DirecTV and EchoStar, so that subscribers can receive signals from the common platform system and from one of the DBS systems, using the same dish, in some embodiments.

Embodiments of the invention may be supported in STBs in a manner that can accommodate services from the common platform system and one or more of the conventional DBS systems. Thus, in some embodiments, there can be DirecTV/common platform compatible set-top boxes 740, EchoStar/common platform compatible set-top boxes 750, and future DBS/common platform compatible set-top boxes. In this way a common platform for TV, audio and/or data services can be established. While DVB-compatible components and technologies can be used in some embodiments, such compatibility need not be used in other embodiments. Rather, other technologies can be used to achieve the same result.

Embodiments of the invention can use standards-based modulation schemes (such as DVB) that are supported in the chipsets used in the set-top boxes, but the use of non-standard modulation technology is not precluded. Embodiments of the invention can use the transport streams that are consistent with the Advanced Television Systems Committee (ATSC) and/or DVB standards, but they need not be used in other embodiments of the invention. Embodiments of the invention can allow EchoStar, DirecTV and future DBS providers to authorize common platform services. Embodiments of the invention can employ extensions to proven DVB SimulCrypt technology to allow multiple conditional access systems to control access to the same services. Embodiments of the invention can carry channel information that can identify common platform channels and programming to the STB, which can be associated with the DBS EPG data streams (which may or may not carry programming information for common platform channels).

STBs according to embodiments of embodiments of the invention can contain chipsets that can decode both the common platform and the DBS video and audio streams. There need be no restriction on the common platform video and audio formats—they can be identical to one of the DBS formats and/or different from them. The DBS/common platform antenna may include a single reflector with multiple feed horns and/or individual reflectors for the DBS and common platform satellites. Array antennas may also be employed. Finally, embodiments of the invention can add data capacity in each market that is accessible by the common platform component in each STB, a PC receiver card and/or other data-centric receive system designed to operate with the common platform.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A Direct Broadcast Satellite (DBS) television receiving system comprising:
a plurality of first and second DBS receivers, the first DBS receivers being configured to receive a first broadcast signal including first television services from a first satellite television network and the second DBS receivers being configured to receive a second broadcast signal including second television services from a second satellite television network, at least some of the first and second DBS receivers also being configured to receive a third broadcast signal including third television services, from a third satellite television network.

2. A system according to claim 1:
wherein the first DBS receivers are further configured to combine the first and third television services into a first user interface; and
wherein the second DBS receivers are further configured to combine the second and third television services into a second user interface.

3. A system according to claim 2:
wherein the first user interface includes a first electronic program guide that includes the first and third television services; and
wherein the second user interface includes a second electronic program guide that includes the second and third television services.

4. A system according to claim 1 wherein the first and second broadcast signals are incompatible with one another.

5. A system according to claim 1:
wherein the first broadcast signal includes therein first DBS receiver authorization messages and third DBS receiver authorization messages for the respective first and third television services that are received at the first DBS receivers; and
wherein the second broadcast signal includes therein second DBS receiver authorization messages and third DBS receiver authorization messages for the respective second and third television services that are received at the second DBS receivers.

6. A system according to claim 5:
wherein the third broadcast signal includes therein the first, second and third DBS receiver authorization messages for the respective first, second and third television services that are received at the first and second DBS receivers.

7. A system according to claim 6:
wherein the first broadcast signal also includes first authentication messages that are associated with the first television services;
wherein the second broadcast signal also includes second authentication messages that are associated with the second television services; and
wherein the third broadcast signal also includes third authentication messages that are associated with the third television services.

8. A system according to claim 1:
wherein the first, second and third broadcast signals include therein respective first, second and third DBS receiver authorization messages for the respective first, second and third television services;
wherein the first, second and third broadcast signals also include therein respective first, second and third authentication messages that are associated with the respective first, second and third television services;
wherein the first DBS receivers are configured to store authorized service information from selected ones of the first and third authorization messages therein and to use a first authentication message or a third authentication message that is associated with a respective first or third television service that is selected by a user of a first DBS receiver, to descramble the respective first or third television service that is selected by the user of the first DBS receiver, if the respective first or third television service that is selected by the user is authorized by the authorized service information from a respective first or third authorization message that is stored in the first DBS receiver; and
wherein the second DBS receivers are configured to store authorized service information from selected ones of the second and third authorization messages therein and to use a second authentication message or a third authentication message that is associated with a respective second or third television service that is selected by a user of a second DBS receiver, to descramble the respective second or third television service that is selected by the user of the second DBS receiver, if the respective second or third service that is selected by the user is authorized by the authorized service information from a respective second or third authorization message that is stored in the second DBS receiver.

9. A system according to claim 8 wherein the first DBS receiver includes a first and a third smart card coupled thereto, wherein the first smart card stores therein the authorized service information from the selected ones of the first authorization messages and wherein the third smart card stores therein the authorized service information from the selected ones of the third authorization messages.

10. A system according to claim 9 wherein the second DBS receiver includes a second and a third smart card coupled thereto, wherein the second smart card stores therein the authorized service information from the selected ones of the second authorization messages and wherein the third smart card stores therein the authorized service information from the selected ones of the third authorization messages.

11. A system according to claim 9 wherein the second DBS receiver includes a fourth smart card coupled thereto, wherein the fourth smart card stores therein the authorized service information from the selected ones of the second authorization messages and the authorized service information from the selected ones of the third authorization messages therein.

12. A system according to claim 5 wherein the first and third DBS receiver authorization messages are configured as Digital Video Broadcasting (DVB) compatible Entitlement Management Messages (EMM).

13. A system according to claim 7 wherein the first and third DBS receiver authorization messages are configured as Digital Video Broadcasting (DVB) compatible Entitlement Management Messages (EMM) and wherein the first, second and third authentication messages are configured as DVB compatible Entitlement Control Messages (ECM).

14. A system according to claim 8 wherein the first and third DBS receiver authorization messages are configured as Digital Video Broadcasting (DVB) compatible Entitlement Management Messages (EMM) and wherein the first, second and third authentication messages are configured as DVB compatible Entitlement Control Messages (ECM).

15. A system according to claim 1 further comprising:
a first space segment that is configured to broadcast the first broadcast signal;
a second space segment that is configured to broadcast the second broadcast signal; and
a third space segment that is configured to broadcast the third broadcast signal.

16. A system according to claim 15 further comprising:
a first ground segment that is configured to obtain the first television services for the first satellite television network;
a second ground segment that is configured to obtain the second television services for the second satellite television network; and
a third ground segment that is configured to obtain the third television services for the first and second television networks.

17. A system according to claim 8 wherein the first and second DBS receivers are configured to descramble the third television service by generating a control word from the third authentication message and using the control word to descramble the third television service.

18. A system according to claim 1 wherein the first satellite television network is a DirecTV satellite television network and wherein the second satellite television network is an EchoStar satellite television network.

19. A Direct Broadcast Satellite (DBS) television receiver for a first satellite television network comprising:
a first network subsystem that is configured to receive a first broadcast signal including first television services, from the first satellite television network; and
a second network subsystem that is configured to receive a common platform broadcast signal including common television services that are common to the first satellite television network and a second satellite television network, from a common platform satellite television network.

20. A receiver according to claim 19 further comprising:
a user interface generator that is configured to combine the first and common television services into a user interface.

21. A receiver according to claim 20:
wherein the user interface includes an electronic program guide that includes the first and common television services.

22. A receiver according to claim 19:
wherein the first broadcast signal includes therein first DBS receiver authorization messages and common DBS receiver authorization messages for the respective first and common television services that are received at the DBS receiver.

23. A receiver according to claim 22:
wherein the common platform broadcast signal includes therein the first and the common DBS receiver authorization messages for the respective first and common television services that are received at the DBS receiver.

24. A receiver according to claim 23:
wherein the first broadcast signal also includes first authentication messages that are associated with the first television services; and
wherein the common platform broadcast signal also includes common authentication messages that are associated with the common television services.

25. A receiver according to claim 19:
wherein the first and common platform broadcast signals include therein respective first and common DBS receiver authorization messages for the respective first and common television services;
wherein the first and common platform broadcast signals also include therein respective first and common authentication messages that are associated with the respective first and common television services; and
wherein the DBS receiver is configured to store authorized service information from selected ones of the first and common authorization messages therein and to use a first authentication message or a common authentication message that is associated with a respective first or common television service that is selected by a user of the DBS receiver, to descramble the respective first or common television service that is selected by the user of the DBS receiver, if the respective first or common television service that is selected by the user is authorized by the authorized service information from a respective first or common authorization message that is stored in the DBS receiver.

26. A receiver according to claim 25 further comprising a first and a second smart card coupled thereto, wherein the first smart card stores therein the authorized service information from the selected ones of the first authorization messages and wherein the second smart card stores therein the authorized service information from the selected ones of the common authorization messages.

27. A receiver according to claim 25 wherein the DBS receiver includes a smart card coupled thereto, wherein the smart card stores therein the authorized service information from the selected ones of the first authorization messages and the authorized service information from the selected ones of the common authorization messages therein.

28. A receiver according to claim 22 wherein the first and common DBS receiver authorization messages are configured as Digital Video Broadcasting (DVB) compatible Entitlement Management Messages (EMM).

29. A system according to claim 24 wherein the first and common DBS receiver authorization messages are configured as Digital Video Broadcasting (DVB) compatible Entitlement Management Messages (EMM) and wherein the first and common authentication messages are configured as DVB compatible Entitlement Control Messages (ECM).

30. A receiver according to claim 25 wherein the DBS receiver is further configured to descramble the common television service by generating a control word from the common authentication message and using the control word to descramble the common television service.

31. A receiver according to claim 19 wherein the first satellite television network is a DirecTV satellite television network or an EchoStar satellite television network.

32. A common platform Direct Broadcast Satellite (DBS) television transmission system comprising:
a ground segment that is configured to receive common DBS television services for first and second DBS television networks and to generate a common platform DBS broadcast signal for the common DBS television services for the first and second DBS television networks; and
a space segment that is configured to transmit the common platform DBS broadcast signal to DBS receivers of both the first and second DBS television networks.

33. A system according to claim 32:
wherein the ground segment is responsive to the first DBS television network to obtain first authorization messages for the common DBS television services and to incorporate the first authorization messages into the common platform DBS broadcast signal; and
wherein the ground segment is responsive to the second DBS television network to obtain second authorization messages for the common DBS television services and to incorporate the second authorization messages into the common platform DBS broadcast signal.

34. A system according to claim 33:
wherein the ground segment is further configured to incorporate first authentication messages for the common DBS television services for the DBS receivers of the first DBS television network into the common platform DBS broadcast signal; and
wherein the ground segment is further configured to incorporate second authentication messages for the common DBS television services for the DBS receivers of the second DBS television network into the common platform DBS broadcast signal.

35. A system according to claim 33:
wherein the ground segment is responsive to the first DBS television network to obtain third authorization messages for unique DBS television services of the first DBS television network and to incorporate the third authorization messages into the common platform DBS broadcast signal; and
wherein the ground segment is responsive to the second DBS television network to obtain fourth authorization messages for unique DBS television services of the second DBS television network and to incorporate the fourth authorization messages into the common platform DBS broadcast signal.

36. A system according to claim 32 wherein the ground segment is further configured to generate a common control word and to scramble the common platform DBS broadcast signal using the common control word.

37. A system according to claim 32 wherein the ground segment is further responsive to a plurality of content providers to receive the common DBS television services for the first and second DBS television networks.

38. A system according to claim 33 wherein the first and second authorization messages are configured as Digital Video Broadcasting (DVB) compatible Entitlement Management Messages (EMM).

39. A system according to claim 34 wherein the first and second authorization messages are configured as Digital Video Broadcasting (DVB) compatible Entitlement Management Messages (EMM) and wherein the first and second authentication messages are configured as DVB compatible Entitlement Control Messages (ECM).

40. A system according to claim 32 wherein the first satellite television network is a DirecTV satellite television network and wherein the second satellite television network is an EchoStar satellite television network.

41. A Direct Broadcast Satellite (DBS) television receiving method comprising:
receiving a first broadcast signal including first television services from a first satellite television network in a DBS receiver; and
receiving a common platform broadcast signal including common television services that are common to the first satellite television network and a second satellite television network, in the DBS receiver.

42. A method according to claim 41 further comprising:
combining the first and common television services into a user interface.

43. A method according to claim 42:
wherein the user interface includes an electronic program guide that includes the first and common television services.

44. A method according to claim 41:
wherein the first broadcast signal includes therein first DBS receiver authorization messages and common DBS receiver authorization messages for the respective first and common television services that are received at the DBS receiver.

45. A method according to claim 44:
wherein the common platform broadcast signal includes therein the first and the common DBS receiver authorization messages for the respective first television services and common television services that are received at the DBS receiver.

46. A method according to claim 45:
wherein the first broadcast signal also includes first authentication messages that are associated with the first television services; and
wherein the common platform broadcast signal also includes common authentication messages that are associated with the common television services.

47. A method according to claim 41:
wherein the first and common platform broadcast signals include therein respective first and common DBS receiver authorization messages for the respective first and common television services;
wherein the first and common platform broadcast signals also include therein respective first and common authentication messages that are associated with the respective first and common television services; and
wherein the method further comprises:
storing authorized service information from selected ones of the first and common authorization messages in the DBS receiver; and
using a first authentication message or a common authentication message that is associated with a respective first or common television service that is selected by a user of the DBS receiver, to descramble the respective first or common television service that is selected by the user of the DBS receiver, if the respective first or common television service that is selected by the user is authorized by the authorized service information from a respective first or common authorization message that is stored in the DBS receiver.

48. A method according to claim 46 wherein the first and common DBS receiver authorization messages are configured as Digital Video Broadcasting (DVB) compatible Entitlement Management Messages (EMM) and wherein the first and common authentication messages are configured as DVB compatible Entitlement Control Messages (ECM).

49. A method according to claim 47 wherein the using comprises:
generating a control word from the common authentication message; and
using the control word to descramble the common television service.

50. A method according to claim 41 wherein the first satellite television network is a DirecTV satellite television network or an EchoStar satellite television network.

51. A Direct Broadcast Satellite (DBS) television transmission signal format comprising:
a plurality of common television services that are common to first and second DBS television networks;
a plurality of first authorization messages that authorize subscribers of the first DBS television network to receive at least one of the plurality of common television services;
a plurality of second authorization messages that authorize subscribers of the second DBS television network to receive at least one of the plurality of common television services;
a plurality of third authorization messages that authorize subscribers of the first DBS television network to receive first television services from the first DBS television network; and
a plurality of fourth authorization messages that authorize subscribers of the second DBS television network to receive second television services from the second DBS television network.

52. A signal format according to claim 51 wherein the common television services and the plurality of first through fourth authorization messages are scrambled using a common control word.

53. A signal format according to claim 51 further comprising:
a plurality of first authentication messages that are used to authenticate subscribers of the first DBS television network who are authorized to receive at least one of the plurality of common television services; and
a plurality of second authentication messages that are used to authenticate subscribers of the second DBS television network who are authorized to receive at least one of the plurality of common television services.

54. A signal format according to claim 51 wherein the first through fourth authorization messages are configured as Digital Video Broadcasting (DVB) compatible Entitlement Management Messages (EMM).

55. A signal format according to claim 53 wherein the first and second authorization messages are configured as Digital Video Broadcasting (DVB) compatible Entitlement Management Messages (EMM) and wherein the first and second authentication messages are configured as DVB compatible Entitlement Control Messages (ECM).

56. A signal format according to claim 51 wherein the first DBS television network is a DirecTV satellite television network and wherein the second DBS television network is an EchoStar satellite television network.

57. A method to add capacity for first and second Direct Broadcast Satellite (DBS) television services that are provided by respective first and second DBS television networks comprising:
broadcasting at least some common DBS television services for the first and second DBS television networks in a common platform DBS broadcast signal that can be received by at least some DBS receivers of both the first and second DBS television networks.

58. A method according to claim 57 wherein the common platform DBS broadcast signal comprises:
a plurality of first authorization messages that authorize subscribers of the first DBS television network to receive at least one of the plurality of common television services; and
a plurality of second authorization messages that authorize subscribers of the second DBS television network to receive at least one of the plurality of common television services.

59. A method according to claim 58 wherein the common platform DBS broadcast signal further comprises:
a plurality of third authorization messages that authorize subscribers of the first DBS television network to receive first television services from the first DBS television network; and
a plurality of fourth authorization messages that authorize subscribers of the second DBS television network to receive second television services from the second DBS television network.

60. A method according to claim 58 wherein the common television services, the plurality of first authorization messages and the plurality of second authorization messages are scrambled using a common control word.

61. A method according to claim 58 wherein the common platform DBS broadcast signal further comprises:
a plurality of first authentication messages that are used to authenticate subscribers of the first DBS television network who are authorized to receive at least one of the plurality of common television services; and
a plurality of second authentication messages that are used to authenticate subscribers of the second DBS television network who are authorized to receive at least one of the plurality of common television services.

62. A method according to claim 58 wherein the first and second authorization messages are configured as Digital Video Broadcasting (DVB) compatible Entitlement Management Messages (EMM).

63. A method according to claim 61 wherein the first and second authorization messages are configured as Digital Video Broadcasting (DVB) compatible Entitlement Management Messages (EMM) and wherein the first and second authentication messages are configured as DVB compatible Entitlement Control Messages (ECM).

64. A method according to claim 57 wherein the first DBS television network is a DirecTV satellite television network and wherein the second DBS television network is an EchoStar satellite television network.

65. A method of adding capacity to a Direct Broadcast Satellite (DBS) receiver that is configured to receive a first broadcast signal including first television services, from a first satellite television network, the method comprising:
configuring the DBS receiver to receive a common platform broadcast signal including common television services that are common to the first satellite television network and a second satellite television network.

66. A method according to claim 65 further comprising:
combining the first and common television services into a user interface at the DBS receiver.

67. A method according to claim 66:
wherein the user interface includes an electronic program guide that includes the first and common television services.

68. A method according to claim 65:
wherein the first broadcast signal includes therein first DBS receiver authorization messages and common DBS receiver authorization messages for the respective first and common television services that are received at the DBS receiver.

69. A method according to claim 68:
wherein the common platform broadcast signal includes therein the first and the common DBS receiver authorization messages for the respective first and common television services that are received at the DBS receiver.

70. A method according to claim 69:
wherein the first broadcast signal also includes first authentication messages that are associated with the first television services; and
wherein the common platform broadcast signal also includes common authentication messages that are associated with the common television services.

71. A method according to claim 65:
wherein the first and common platform broadcast signals include therein respective first and common DBS receiver authorization messages for the respective first and common television services;
wherein the first and common platform broadcast signals also include therein respective first and common authentication messages that are associated with the respective first and common television services; and
wherein the method further comprises:
storing authorized service information from selected ones of the first and common authorization messages in the DBS receiver; and
using a first authentication message or a common authentication message that is associated with a respective first or common television service that is selected by a user of the DBS receiver, to descramble the respective first or common television service that is selected by the user of the DBS receiver, if the respective first or common television service that is selected by the user is authorized by the authorized service information from a respective first or third authorization message that is stored in the DBS receiver.

72. A receiver according to claim 68 wherein the first and common DBS receiver authorization messages are configured as Digital Video Broadcasting (DVB) compatible Entitlement Management Messages (EMM).

73. A method according to claim 70 wherein the first and common DBS receiver authorization messages are configured as Digital Video Broadcasting (DVB) compatible Entitlement Management Messages (EMM) and wherein the first and common authentication messages are configured as DVB compatible Entitlement Control Messages (ECM).

74. A method according to claim 71 wherein the using comprises:
generating a control word from the common authentication message; and
using the control word to descramble the common television service.

75. A method according to claim 68 wherein the first DBS television network is a DirecTV satellite television network or an EchoStar satellite television network.

76. A method to add capacity for first and second Direct Broadcast Satellite (DBS) subscription services that are provided by a DBS television network comprising:
broadcasting at least some common DBS television services for the first and second DBS subscription services in a common platform DBS broadcast signal that can be received by at least some DBS receivers of both the first and second subscription services.

77. A method according to claim 76 wherein the common platform DBS broadcast signal comprises:
a plurality of first authorization messages that authorize subscribers of the first DBS subscription services to receive at least one of the plurality of common television services; and
a plurality of second authorization messages that authorize subscribers of the second DBS subscription services to receive at least one of the plurality of common television services.

78. A method according to claim 77 wherein the common platform DBS broadcast signal further comprises:
a plurality of third authorization messages that authorize subscribers of the first DBS subscription services to receive first television services from the first DBS television network; and
a plurality of fourth authorization messages that authorize subscribers of the second DBS subscription services to receive second television services from the second DBS television network.
